(19) United States
(12) Patent Application Publication
(10) Pub. No.: US 2016/0321623 A1
(43) Pub. Date: Nov. 3, 2016

(54) AUTOMATED TELLER MACHINE FEE PREPAYMENT AND REWARD SYSTEM AND METHOD

(71) Applicant: MASTERCARD INTERNATIONAL INCORPORATED, Purchase, NY (US)

(72) Inventors: Shekhar Sahgal, Stamford, CT (US); Ryan Bodman, Louisville, KY (US); Der Pei Wang, Scarsdale, NY (US); Beth Marie Griffin, Delafield, WI (US); Stephen Parento, White Plains, NY (US)

(73) Assignee: MASTERCARD INTERNATIONAL INCORPORATED, Purchase, NY (US)

(21) Appl. No.: 14/700,813

(22) Filed: Apr. 30, 2015

(51) Int. Cl. G06Q 20/10; G06Q 30/02

(52) U.S. Cl. CPC G06Q 20/102; G06Q 20/105; G06Q 20/1085; G06Q 30/0232; G06Q 30/0237

(57) ABSTRACT

Systems and methods of providing a flat fee automated teller machine (“ATM”) program are described. An operator of a transacted ATM may receive an inquiry from the ATM regarding whether a transacted ATM card is enrolled in the flat fee ATM program. The ATM operator may have access a database to determine if the transacted ATM card is enrolled in the flat fee ATM program, or the ATM operator may transmit the inquiry to the transacted ATM card's issuer, through a payment card network. The ATM operator may instruct the transacted ATM whether to charge a transaction fee depending on information accessed in the database by the ATM operator or on a response generated by the ATM card issuer.

### FIELD OF TECHNOLOGY

The present disclosure is in the field of electronic fund transfer and, more particularly involves the field of electronic fund transfers using automated teller machine (ATM) networks and payment card networks.

### BACKGROUND

Automated teller machines (“ATM”) are generally coupled to financial institutions via one or more ATM networks. The ATM networks may be coupled together via higher level electronic fund transfer networks such as regional ATM networks and national ATM networks for processing and routing ATM transactions between a consumer and a financial institution. National ATM networks are generally affiliated with and/or integrated with payment card networks, which are configured to process credit card transactions, debit card transactions, and pre-paid card transactions and to route payments from consumer accounts in a payment card issuing financial institution to a merchant institution for settling the respective transactions. The term “payment card network” and “national ATM network” may be used interchangeably herein. One example of a payment card network is the well-known payment card network owned and operated by MasterCard, of Purchase, N.Y., U.S.A.

The term “ATM network” as used herein refers to regional ATM networks and/or lower level ATM networks that may be coupled to a regional or national ATM network. ATM networks may include networks owned by ATM card issuers, other financial institutions and independent ATM owners that may not be affiliated with a financial institution. ATM networks are generally coupled to regional ATM networks and/or national ATM networks. Each ATM network and payment card network generally includes one or more network computer systems coupled to one or more ATMs or to one or more network computer systems of other ATM networks. Each of the network computer systems generally includes one or more processors coupled to one or more data storage devices and/or data warehouses. Some of the network computer system processors may be configured as gateways and or switches to route electronic signals representing transaction information between selected ATMs, ATM networks, payment card networks, and/or financial institutions.

ATM cards are generally issued by financial institutions (ATM card issuers) which may be affiliated with one or more of the national and/or regional ATM networks. In addition independent ATM owners and independent ATM networks may be affiliated with one or more financial institutions and coupled to one or more of the national or regional ATM networks.

ATMs are generally configured to distinguish between in-network ATM cards, which are issued by ATM card issuers affiliated with the same network as the ATM and out-of-network ATM cards that are issued by ATM card issuers affiliated with other ATM networks. ATMs and/or ATM networks may also be configured to determine whether to apply foreign (out-of network) surcharge to an ATM transaction based on whether an ATM card being used to perform a transaction on an ATM is an in-network ATM card or an out-of network ATM card. Traditionally, ATM transactions that are performed using in-network ATM cards, are not charged a surcharge but ATM transactions that are performed using out-of-network ATM cards are charged surcharge ATM transaction fees by the ATM owner for transactions performed on an ATM. Independent ATM networks which are not affiliated with an ATM issuer may charge surcharge for all ATM transactions on their ATMs.

Additional ATM transaction fees called foreign fees may also be charged to an ATM cardholder account by a card issuer for transactions on an ATM that is not a member of an ATM network affiliated with the ATM card issuer Foreign fees that may be charged to ATM users are generally defined by the terms of the user's ATM account with the ATM issuer.

### SUMMARY

The present disclosure describes systems and methods for implementing a surcharge free ATM card program in which a program operator such as an ATM network owner, an ATM card issuer or a payment card network receives a one time or periodic fee or other value such as loyalty program points from ATM cardholders in exchange for applying a no-surcharge status to transactions using the ATM card. The no-surcharge status may be communicated to an ATM owner by a program operator along with ATM transaction information to inform the ATM owner that a surcharge should not be applied. Separate transactions or contractual agreements between program operators and ATM owners are implemented to compensate the ATM owner for the waived surcharge amounts.

An aspect of the present disclosure relates to a method for performing an ATM transaction comprising the steps of receiving a debit order for a transaction and an inquiry from an ATM and sending the debit order to a payment card network. The debit order may include a requested transaction amount and the inquiry may include identifying information associated with a transacted ATM card. The payment card network may be coupled to a plurality of card ATM card issuers. The method may further include receiving a response to the debit order from the payment card network and accessing a flat fee program database using the identifying information of the inquiry to determining whether the transacted ATM card is enrolled in a flat fee ATM program. Moreover, the method may include sending instructions to the ATM that relate to whether the requested transaction should be performed and whether a transaction fee should be applied to the requested transaction.

The flat fee program database may include account information of ATM cards enrolled in the flat fee ATM program. Moreover, the flat fee program database may include ATM read able card numbers and user identifying information. The debit order may include payment card network information identifying the payment card network affiliated with the transacted ATM card. The payment card network may be a card associated affiliated with the transacted ATM card. The method may further include determining whether the response to the debit order indicates a user account affiliated with the ATM card has sufficient funds to back the requested transaction.

Another aspect of the present disclosure relates to a method for performing an ATM transaction comprising the steps of receiving a debit order for a transaction and an inquiry from an ATM and sending the debit order and the inquiry to a payment card network. The debit order may include a requested transaction amount and the payment card network may be coupled to a plurality of ATM card issuers. The method may further include receiving a response to the debit order and the inquiry from the payment card network and sending instructions to the ATM. The response may indicate whether sufficient funds exist in a user account to back the requested transaction amount and whether a transacted ATM card is enrolled in a flat fee ATM program. The instructions may relate to whether a requested transaction should be performed and whether a transaction fee should be applied to the requested transaction.

Additionally, the method may include determining whether the response indicates the transacted ATM card is enrolled in the flat fee program. The debit order and inquiry may include information identifying the payment card network affiliated with the transacted ATM card. Further, the inquiry may include a request for information evidencing whether the transacted ATM card is enrolled in the flat fee ATM program.

A further aspect of the present disclosure relates to a device having a processor operable to receive a debit order and an inquiry from an ATM and transmit at least one of the debit order and inquiry to a payment card network. The debit order and inquiry may be specific to a requested ATM transaction and the inquiry may further include information useable for determining whether a transacted ATM card is enrolled in a flat fee ATM program. The payment card network may be coupled to a plurality of ATM card issuers. The processor may further be operable to receive a response to at least one of the debit order and the inquiry from the payment card network. Moreover, the processor may be operative to determine whether the requested ATM transaction should be assessed a transaction fee and transmit instructions to the ATM stating whether the requested ATM transaction should be assessed the transaction fee.

The processor may be further operative to analyze the response and/or to access a flat fee ATM program database to determine whether the transacted ATM card is enrolled in the flat fee ATM program. The flat fee ATM program database may include ATM card numbers affiliated with ATM cards enrolled in the flat fee ATM program. The debit order may include a requested transaction amount, ATM card identifying information, affiliated payment card network information, and affiliated ATM card issuer information. The processor may also be operative to determine whether the requested ATM transaction should be performed and to analyze the response to determine whether the requested ATM transaction should be performed. Moreover, the processor may be operative to transmit instructions to the ATM stating whether the requested ATM transaction should be performed. The inquiry may include ATM card identifying information, affiliated user information, affiliated payment card network information, and affiliated ATM card issuer information. Furthermore, the processor may be operative to transmit the debit order and the inquiry to the payment card network using affiliated payment card network information contained within the debit order and/or the inquiry.

An aspect of the present disclosure relates to a method for performing an ATM transaction. The method includes an ATM reading an ATM card to access a user account and the ATM sending a request to a payment card network that is coupled to card issuers. The request includes a request to one of the card issuers for a plan membership status of the ATM user. Further, the method includes the ATM receiving the plan membership status from the payment card network. Additionally, an ATM transaction requested by the ATM user is performed without charging ATM transaction fees to the ATM user in response to receiving the plan membership status indicating an active membership status of the user.

Another aspect of the present disclosure relates to a method for performing an ATM transaction including an ATM reading an ATM card to access a user account. The ATM also receives a code entered by the ATM user. The method also includes sending a request on a payment card network to verify that the code corresponds to a valid reward. Moreover, an ATM transaction requested by the ATM user is performed without charging ATM transaction fees to the ATM user in response to receiving the one-time usable code.

Yet another aspect of the present disclosure relates to an electronic funds transfer (EFT) system. The system includes an ATM operator computer coupled to an ATM. The ATM operator computer includes at least one processor and at least one data storage apparatus. The system also includes a subscription database stored in the at least one data storage apparatus. The subscription database contains status information indicating a subscription status of at least two subscriber ATM cardholders. The ATM operator computer receives a transaction request from the ATM. The request includes account identifying information of the ATM user. The ATM operator computer also searches the subscription database for information indicating the subscription status of the ATM user based on the account identifying information. Moreover, the ATM operator computer determines the subscription status of the ATM user based on the status information. When the subscription status of the ATM user is determined to be active, the ATM operator computer transmits a no-fee authorization to the ATM.

A further aspect of the present disclosure relates to an EFT system including an ATM network computer coupled to at least one financial institution computer and at least one ATM operator computer. The at least one ATM operator computer are each coupled to at least one ATM. The ATM network computer includes at least one processor and at least one data storage apparatus. The system further includes a subscription database stored in the at least one data storage apparatus. The subscription database contains status information indicating a subscription status of at least two subscriber ATM cardholders. Further, the ATM network receives a transaction request from the ATM via the at least one ATM operator computer. This transaction request includes account identifying information of the ATM user. The ATM network computer also searches the subscription database for information indicating the subscription status of the ATM user based on the account identifying information. The ATM network computer further determines the subscription status of the ATM user based on the status information. When the subscription status of the ATM user is determined to be active, the ATM network computer transmits a no-fee authorization to the ATM via the at least one ATM operator computer.

Additional features and advantages of the present disclosure are described below. It should be appreciated by those skilled in the art that this disclosure may be readily utilized as a basis for modifying or designing other structures, systems and processes for carrying out the same purposes of the present disclosure. It should also be realized by those skilled in the art that such equivalent implementations do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The particular features and advantages of the present disclosure will be apparent from the detailed description set forth below in conjunction with the drawings in which like reference characters identify corresponding aspects throughout.

FIG. 1 is a conceptual block diagram illustrating a general system for providing a flat fee automated teller machine program according to the present disclosure.

FIG. 2 is a system flow diagram detailing a method for enrolling a cardholder in a flat fee automated teller machine program according to the present disclosure.

FIG. 3 is a system flow diagram detailing a method for providing an automated teller machine transaction involving an out-of-network automated teller machine card according to the present disclosure.

FIG. 4 is a system flow diagram detailing a method for enrolling a cardholder in a flat fee automated teller machine program according to the present disclosure.

FIG. 5 is a system flow diagram detailing a method for providing an automated teller machine transaction involving an out-of-network automated teller machine card according to the present disclosure.

FIG. 6 is a process flow diagram detailing a method for performing an ATM transaction according to the present disclosure.

FIG. 7 is a process flow diagram detailing a method for performing an ATM transaction according to the present disclosure.

FIGS. 8A and 8B are a process flow diagram detailing a method for performing an ATM transaction according to the present disclosure.

FIG. 9 is a process flow diagram detailing a method for performing an ATM transaction according to the present disclosure.

FIG. 10 is a block diagram detailing a system for providing a flat fee automated teller machine program according to the present disclosure.

### DETAILED DESCRIPTION OF EMBODIMENTS

The detailed description set forth herein makes reference to the accompanying drawings, which show various aspects of the present disclosure by way of illustration. While these various aspects are described in sufficient detail to enable those skilled in the art to practice the disclosure, it should be understood that other embodiments and implementations may be realized and that logical and mechanical changes may be made without departing from the scope of the disclosure. Thus, the detailed description herein is presented for purposes of illustration only and not of limitation. For example, the steps recited in the method or process descriptions may be executed in any order and are not limited to the order presented, unless specifically and explicitly indicated.

According to an aspect of the present disclosure, an ATM card issuer may invite its ATM cardholders to subscribe to a flat fee payment program in which the ATM cardholders pay a periodic flat subscription fee rather than charging per-transaction issuer fee. The ATM cardholder may subscribe to the flat fee payment program upon opening an ATM account with the ATM card issuer, or later by subscribing on the ATM card issuer's website, by telephone or by interaction with an ATM of the ATM card issuer, for example. According to this aspect of the present disclosure, the flat fee payment program may be implemented by the ATM card issuer which may maintain its own database of subscribers, or by the a payment card network coupled in operable communication with the ATM card issuer. The payment card network may maintain a database of subscribers for one or more ATM card issuers, for example.

According to another aspect of the present disclosure, an ATM network operator may invite its ATM users to subscribe to a flat periodic subscription fee in which the ATM users pay a periodic flat subscription fee rather than charging a per-transaction ATM operator fees. ATM cardholders may subscribe to the flat fee payment program of the ATM network operator by subscribing on the ATM network's website, by telephone or by interaction with an ATM of the ATM network operator, for example. According to this aspect of the present disclosure, the flat fee payment program may be implemented by a payment card network coupled in operable communication with the ATM network operator and which maintains a database of subscribers for one or more ATM network operators, for example.

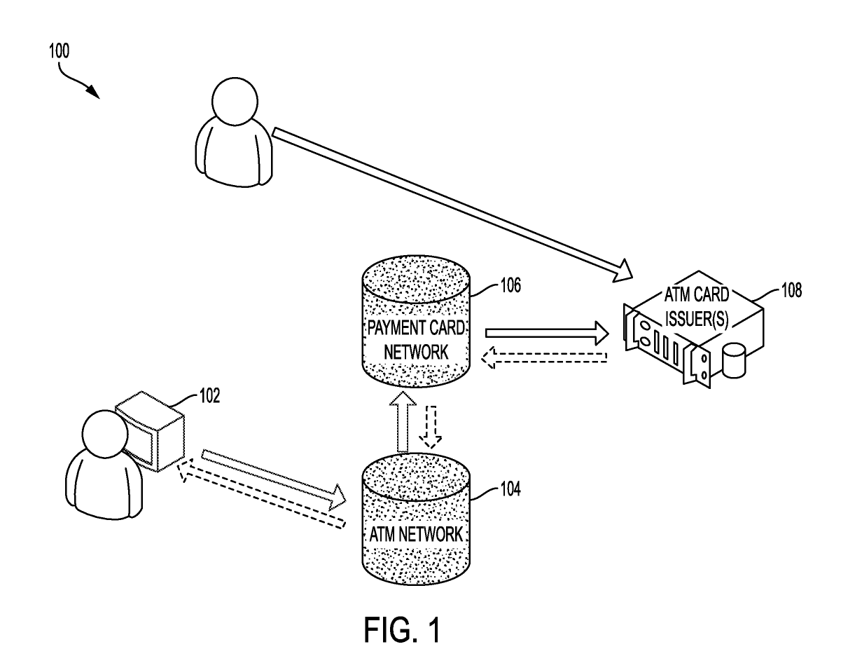

FIG. 1 provides a general overview of a system 100 configured for implementing a flat fee ATM program according to an aspect of the present disclosure. The system 100 includes one or more ATMs 102 coupled in operable communication with an ATM operator network 104. The ATM operator network 104 is coupled in operable communication with a payment card network 106. The payment card network 106 is coupled in operable communication with one or more ATM card issuers 108.

The ATM 102 is configured to exchange transaction information with the ATM operator 104. The transaction information includes information, such as ATM card numbers and/or other identifying information pertaining to an ATM card, for example.

The ATM operator network 104 may be an entity having a network of ATMs that it owns and/or operates. The ATM operator network 104 may be a large regional ATM network or may be a smaller ATM network owned by an ATM card issuer financial institution, a chain of retail establishments, food establishments, or other independent entities, for example.

The payment card network 106 may be an entity, such as a card association, that acts as a custodian and/or clearing house for payment cards it is affiliated with.

The payment card network 106 and the ATM card issuer 108 may be unaffiliated with the network of ATMs 104. That is, the payment card network 106 and ATM card issuer 108 may not own and/or operate the network of ATMs 104.

The presence of the payment card network 106 allows networked ATMs 102 to communicate with an ATM card issuer 108 unaffiliated with the ATM operator 104, instead of just one affiliated with the ATM operator 104.

The ATM card issuer 108 may be an entity, such as a bank or other financial institution, that issues ATM cards to users. Such ATM cards may include, for example, credit/debit cards, debit cards, and various prepaid/preloaded cards that may be used in an ATM and which are conventionally subjected to ATM transaction fees, for example. The ATM cards issued by the ATM card issuer 108 may be affiliated with one or more payment card networks 106 and/or one or more ATM operator networks 104 based on contractual relationships between the ATM card issuer and the ATM operator networks 104, and/or the payment card networks 106.

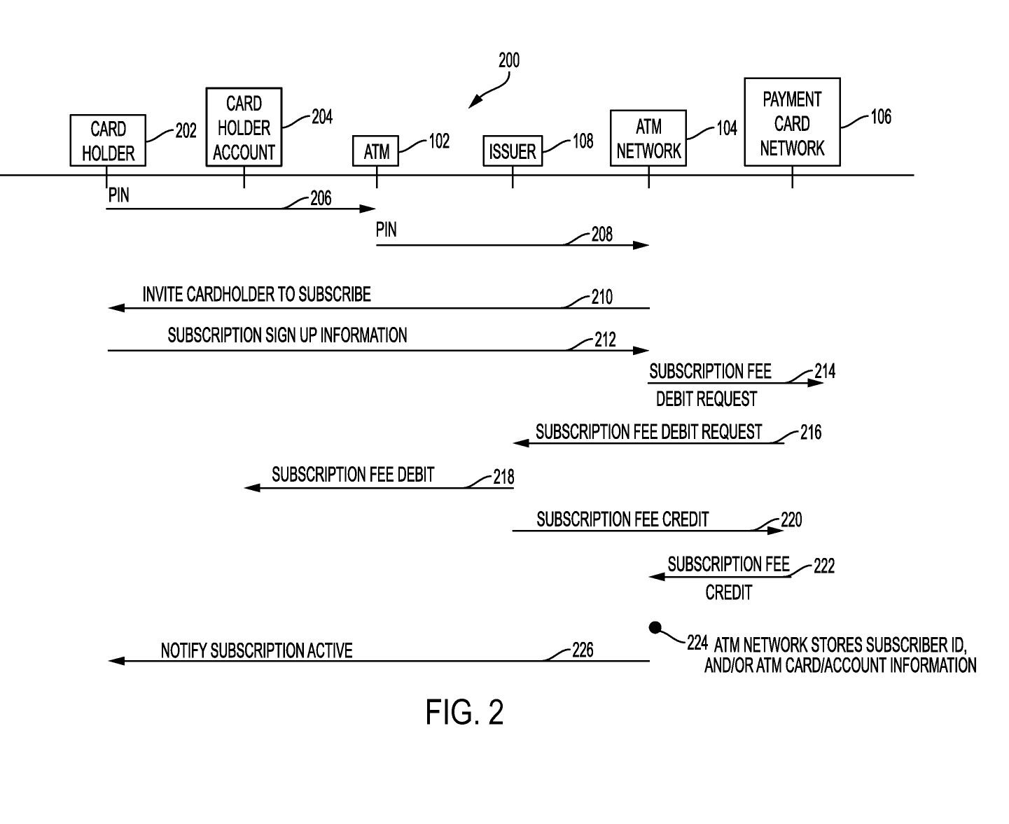

FIG. 2 details a system 200 for enrolling a cardholder in a flat fee ATM program wherein the ATM network 104 maintains a flat fee program subscriber list. The system 200 includes a cardholder 202, a cardholder account 204, the ATM 102, the ATM card issuer 108, the ATM network 104, and the payment card network 106.

During an ATM transaction, the cardholder 202 presents the ATM 102 with an out-of-network ATM card and its corresponding personal identification number (“PIN”), thereby authorizing the ATM transaction (illustrated as 206). The PIN and/or other ATM card identifying information is ultimately transmitted to the ATM network 104 (illustrated as 208). This other ATM card identifying information may include a card number, expiration date, affiliated cardholder data, affiliated payment card network data, and affiliated ATM card issuer data, for example. The ATM network 104 thereby invites the cardholder 202 to subscribe to the flat fee ATM program (illustrated as 210) and receives program subscription sign up information from the cardholder 202 (illustrated as 212). This subscription sign up information may include, for example, user identifying information such as an address, email, and telephone number, and ATM card identifying information such as a card number, expiration data, affiliated payment card network information, and affiliated ATM card issuer information.

Upon receiving the subscription signup information, the ATM network 104 transmits a subscription fee debit request to the payment card network 106 (illustrated as 214), which transmits the subscription fee debit request to the issuer 108 affiliated with the transacted ATM card (illustrated as 216). The issuer 108 in turn debits the subscription fee amount from the cardholder's card account 204 (illustrated as 218). The issuer 108 also transmits a subscription fee credit, equal to the subscription fee amount, to the payment card network 106 (illustrated as 220), which transmits the subscription fee credit to the ATM network 104 (illustrated as 222). The ATM network 104 stores subscription information in an ATM flat fee program subscriber data warehouse (illustrated as 224). This subscription information includes a subscriberID and/or ATM card/account information. The subscriberID is unique to the cardholder 202 and includes information sufficient to identify the particular cardholder 202, such as name, address, and the like. The ATM network 104 also notifies the cardholder 202 that their subscription to the flat fee program is active (illustrated as 226). This subscription notification may include information, such as the ATM card number that is flagged as being part of the flat fee program, for example. The ATM 102 may provide the cardholder 202 with the subscription notification by displaying it on the ATM's screen, and/or by providing the cardholder 202 with a receipt verifying the subscription.

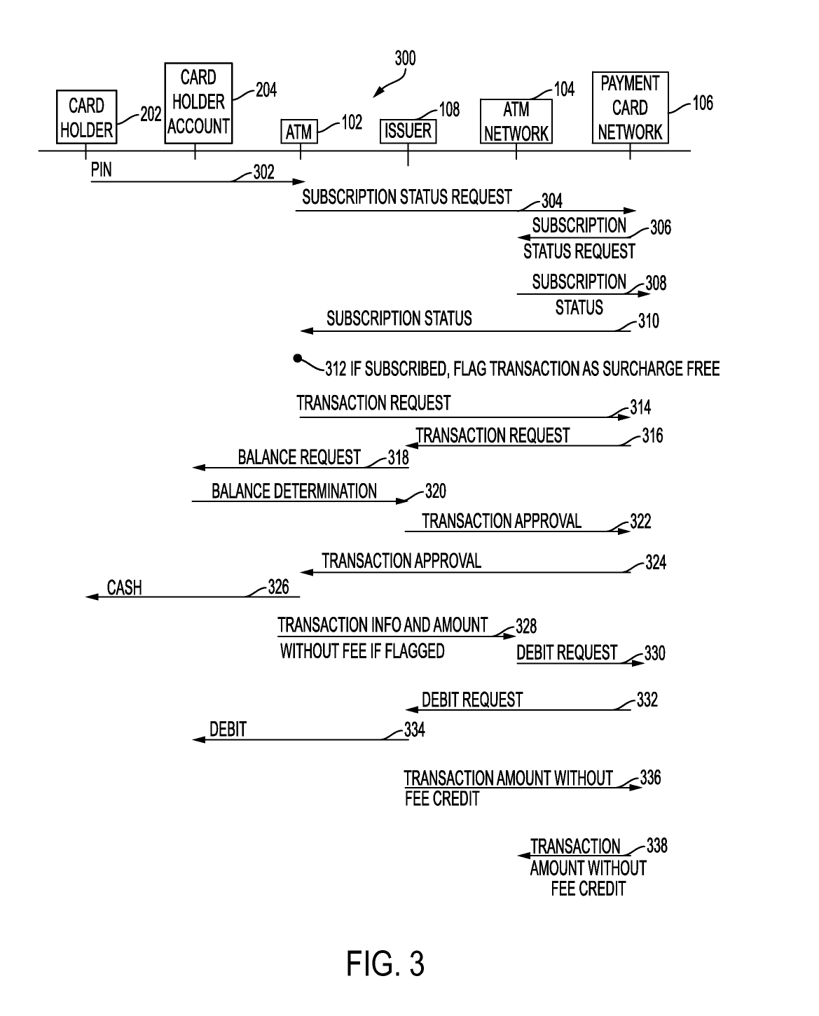

FIG. 3 illustrates a system 300 for providing an ATM transaction involving an out-of-network ATM card wherein the ATM 102 flags transactions as feeless. The system 300 includes the cardholder 202, the cardholder account 204, the ATM 102, the issuer 108, the ATM network 104, and the payment card network 106.

During an ATM transaction, the cardholder 202 presents the ATM 102 with the out-of-network ATM card and its corresponding PIN, thereby authorizing the ATM transaction (illustrated as 302). To determine whether the transacted ATM card is subscribed to the flat fee ATM program, the ATM 102 sends a subscription status request to the payment card network 106 (illustrated as 304). The subscription status request may include a card number, expiration date, affiliated cardholder data, affiliated payment card network data, and affiliated ATM card issuer data, for example. The payment card network 106 in turn transmits the subscription status request to the ATM network 104 (illustrated as 306). The ATM network, having the subscriber database referenced in FIG. 2, determines whether the transacted ATM card is subscribed to the flat fee ATM program, and transmits the subscription status of the ATM card to the payment card network 106 (illustrated as 308). The payment card network 106 thereby transmits the subscription status to the ATM 102 (illustrated as 310). If the subscription status evidences the transacted ATM card is subscribed to the flat fee program, the ATM 102 flags the requested ATM transaction as surcharge/fee free (illustrated as 312).

Along with determining a subscription status of the transacted ATM card, the requested ATM transaction is settled. Part of settling an ATM transaction involves ensuring sufficient funds exist to back the requested ATM transaction. For this, the ATM 102 transmits a transaction request to the payment card network 106 (illustrated as 314). The transaction request may include a card number, expiration date, affiliated cardholder data, affiliated payment card network data, affiliated ATM card issuer data, and a transaction amount, for example. The payment card network 106 in turn transmits the transaction request to the issuer 108 of the transacted ATM card (illustrated as 316). The issuer 108 thereby transmits a balance request to the cardholder account 204, affiliated with the transacted ATM card, to ensure sufficient funds exist to back the requested transaction (illustrated as 318). The cardholder account 204 in response submits a balance determination to the issuer 108 evidencing whether sufficient funds exist (illustrated as 320). If the balance is sufficient, the issuer 108 transmits a transaction approval to the payment card network 106 (illustrated as 322), which transmits the transaction approval to the ATM 102 (illustrated as 324). The ATM 102 thereby dispenses cash, equal to the requested transaction amount, to the cardholder 202 (illustrated as 326).

Another part of the settlement process involves ensuring the right parties debit and credit amounts accordingly. For this, the ATM 102 transmits transaction information including a transaction amount to the ATM network 104 (illustrated as 328). This transaction amount does not include a surcharge/fee if the transaction was flagged as involving an ATM card subscribed to the flat fee program. The ATM network 104 in turn transmits a debit request, equaling only the requested transaction amount, to the payment card network 106 (illustrated as 330). The payment card network 106 transmits the debit request to the issuer 108 (illustrated as 332) and the issuer 108 debits the cardholder account 204 (illustrated as 334). The issuer 108 also transmits the transaction amount credit, equal to the requested transaction amount, to the payment card network 106 (illustrated as 336), and the payment card network 106 transmits the credit to the ATM network 104 (illustrated as 338).

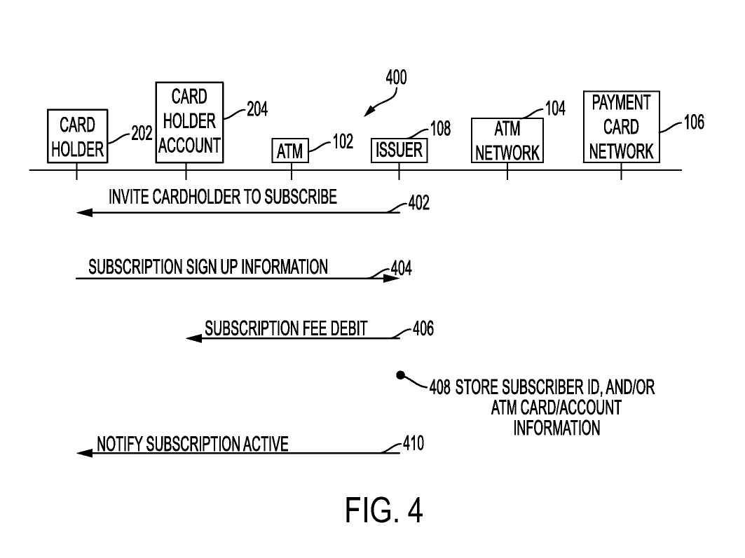

FIG. 4 illustrates a system 400 for enrolling a cardholder in a flat fee ATM program wherein the issuer 108 maintains a flat fee program subscriber list. The system 400 includes the cardholder 202, the cardholder account 204, the ATM 102, the ATM card issuer 108, the ATM network 104, and the payment card network 106.

The issuer 108 invites the cardholder 202 to subscribe to the flat fee ATM program (illustrated as 402). This invitation may be conveyed to the cardholder 202 when the ATM card is issued to the cardholder 202. The issuer 108 also receives subscription signup information from the cardholder 202 (illustrated as 404). This subscription signup information may include a subscriberID and/or ATM card/account information. The subscriberID is unique to the cardholder 202 and includes information sufficient to identify the particular cardholder 202, such as name, address, and the like. The ATM card/account information may include a card number, expiration date, affiliated cardholder data, and affiliated payment card network data, for example. Moreover, the issuer 108 debits the subscription fee from the cardholder account 204 affiliated with the ATM card (illustrated as 406). The issuer 108 also stores the received subscriberID and/or ATM card/account information in a flat fee program subscriber database (illustrated as 408). Additionally, the issuer 108 notifies the cardholder 202 when the subscription is active (illustrated as 410).

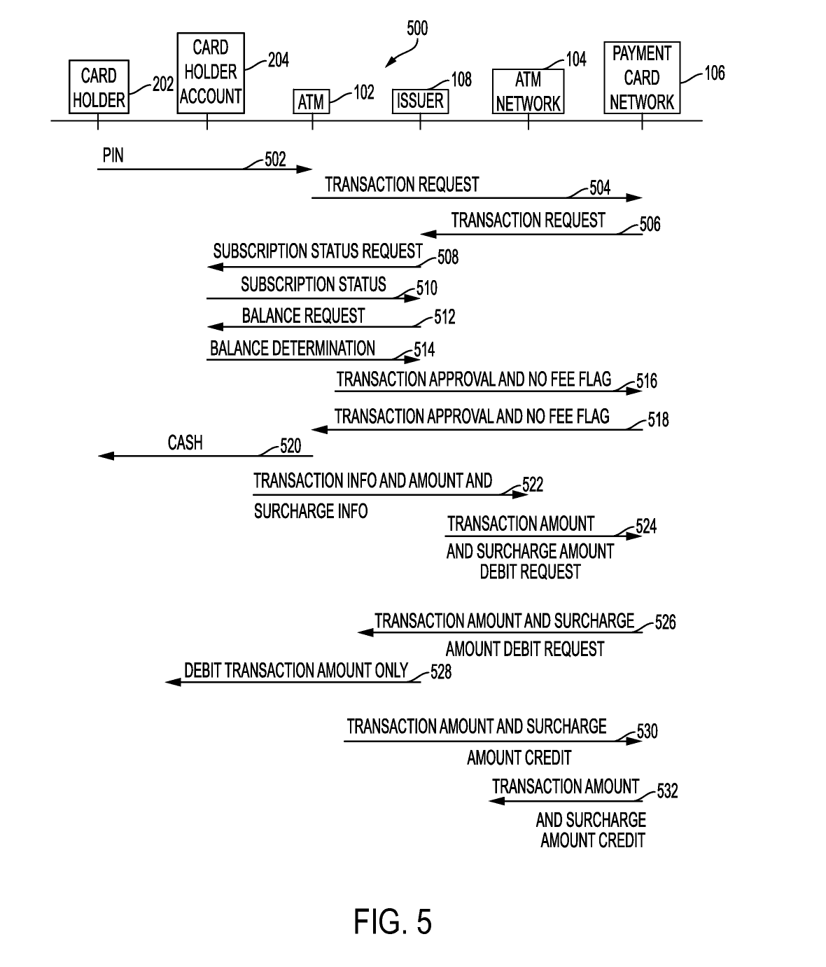

FIG. 5 details a system 500 for providing an ATM transaction involving an out-of-network ATM card wherein the ATM card issuer 108 flags transactions as feeless. The system 300 includes the cardholder 202, the cardholder account 204, the ATM 102, the issuer 108, the ATM network 104, and the payment card network 106.

When an ATM transaction is initiated, the cardholder 202 presents the ATM 102 with the out-of-network ATM card and its corresponding personal identification number (“PIN”) and the ATM 102 transmits a transaction request to the payment card network 106 (illustrated as 504). The transaction request may include a requested transaction amount and identifying information, such as cardholder 202 and ATM card identifying information, for example. The payment card network 106 transmits the transaction request to the issuer 108 (illustrated as 506) and the issuer 108 thereby transmits a subscription status request to the cardholder account 204 affiliated with the transacted ATM card to determine whether the ATM card is subscribed to the flat fee program (illustrated as 508). The cardholder account 204 in response transmits the ATM card's subscription status to the issuer 108 (illustrated as 510).

To ensure sufficient funds exist to back the requested transaction, the issuer 108 transmits a balance request to the cardholder account 204 (illustrated as 512). In response, the cardholder account 204 submits a balance determination to the issuer 108 evidencing whether sufficient funds exist to back the requested transaction (illustrated as 514). If the balance is sufficient and the cardholder account 204 is subscribed to the flat fee program, the issuer 108 transmits a transaction approval with a no surcharge/fee flag to the payment card network 106 (illustrated as 516), which in turn transmits the transaction approval and no surcharge/fee flag to the ATM 102 (illustrated as 518). The ATM 102 thereby dispenses cash to the cardholder 202 (illustrated as 520).

The following describes an ATM transaction settlement process according to the present disclosure. The ATM 102 transmits transaction information, including transaction amount, and surcharge amount information to the ATM network 104 (illustrated as 522). This surcharge amount information evidences the surcharge applied by the ATM 102 to out-of-network transactions. The ATM network 104 transmits a debit request for the transaction amount and surcharge amount to the payment card network 106 (illustrated as 524), which transmits the debit request to the issuer 108 of the transacted ATM card (illustrated as 526). The issuer 108 debits only the transaction amount from the cardholder account 204 (illustrated as 528). Moreover, the issuer 108 transmits a credit for both the transaction amount and surcharge amount to the payment card network 106 (illustrated as 530). To complete the settlement process, the payment card network 106 transmits the credit for both the transaction amount and surcharge amount to the ATM network 104 (illustrated as 532).

While it is described herein, specifically with reference to FIGS. 3 and 5, that the payment card network 106 performs the settlement/clearing of the requested out-of-network ATM transaction, one skilled in the art should appreciate that a clearinghouse financial institution, such as the U.S. Federal Reserve Bank, may perform some or all settlement and/or clearing steps instead of or in addition to the payment card network 106. Further, while the description herein particularly describes both the ATM 102 and the issuer 108 being configured to flag a transaction involving an out-of-network ATM card as being feeless, one skilled in the art should appreciate an aspect of the present disclosure wherein the payment card network 106 is configured to flag a transaction involving an out-of-network ATM card as being feeless.

According to aspects of the present disclosure, loyalty points may be earned by ATM cardholders according to terms of a loyalty program implemented by an ATM owner or ATM network owner, for example. A predetermined number of earned loyalty points may be redeemed by the cardholder as payment for some or all of the periodic subscription payment for the no-fee ATM transaction program.

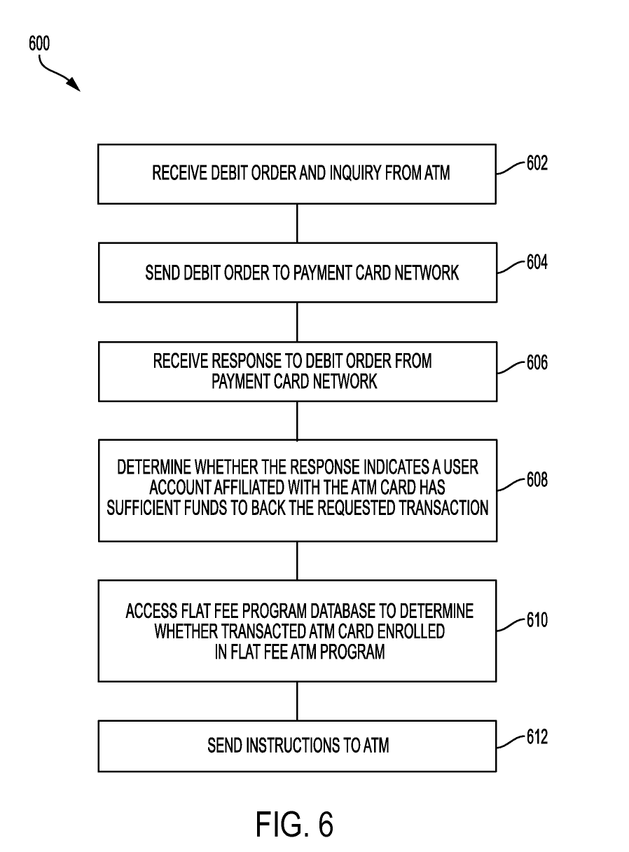

FIG. 6 illustrates a method 600 for performing an ATM transaction according to the present disclosure. At block 602 a debit order and an inquiry is received from an ATM. The debit order includes a requested transaction amount and the inquiry includes identifying information associated with a transacted ATM card. The debit order may further include payment card network information identifying the payment card network affiliated with the transacted ATM card. At block 604 the debit order is sent to a payment card network, which communicates with ATM card issuers. The payment card network may be a card association affiliated with the transacted ATM card. At block 606 a response to the debit order is received from the payment card network. At block 608 it is determined whether the response to the debit order indicates a user account affiliated with the ATM card has sufficient funds to back the requested transaction. At block 610 a flat fee program database is accessed using the identifying information of the inquiry to determine whether the transacted ATM card is enrolled in a flat fee ATM program. The flat fee program database may include account information of ATM cards enrolled in the flat fee ATM program. Moreover, the flat fee program database may include ATM card numbers and user identifying information. At block 612 instructions are sent to the ATM. The instructions relate to whether the requested transaction should be performed and whether a transaction fee should be applied to the requested transaction.

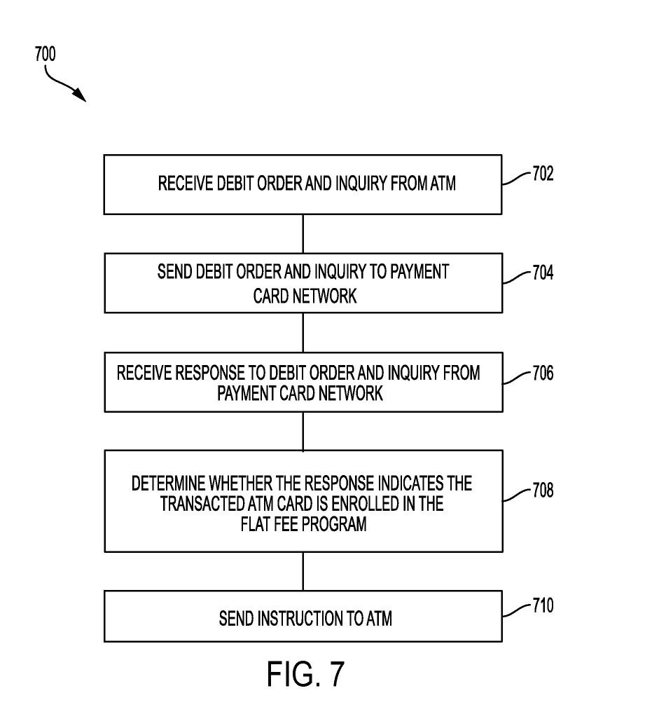

FIG. 7 details a method 700 for performing an ATM transaction according to the present disclosure. At block 702 a debit order and an inquiry are received from an ATM. The debit order includes a requested transaction amount. Moreover, the debit order and the inquiry may include information identifying the payment card network affiliated with the transacted ATM card. The inquiry may further include a request for information evidencing whether the transacted ATM card is enrolled in the flat fee program. At block 704 the debit order and the inquiry are sent to a payment card network that is in communication with ATM card issuers. At block 706 a response to the debit order and the inquiry is received from the payment card network. The response indicates whether sufficient funds exist in a user account to back the requested transaction amount and whether the transacted ATM card is enrolled in the flat fee ATM program. At block 708 it is determined whether the response indicates the transacted ATM card is enrolled in the flat fee program. At block 710 instructions are sent to the ATM. The instructions relate to whether the requested transaction should be performed and whether a transaction fee should be applied to the requested transaction.

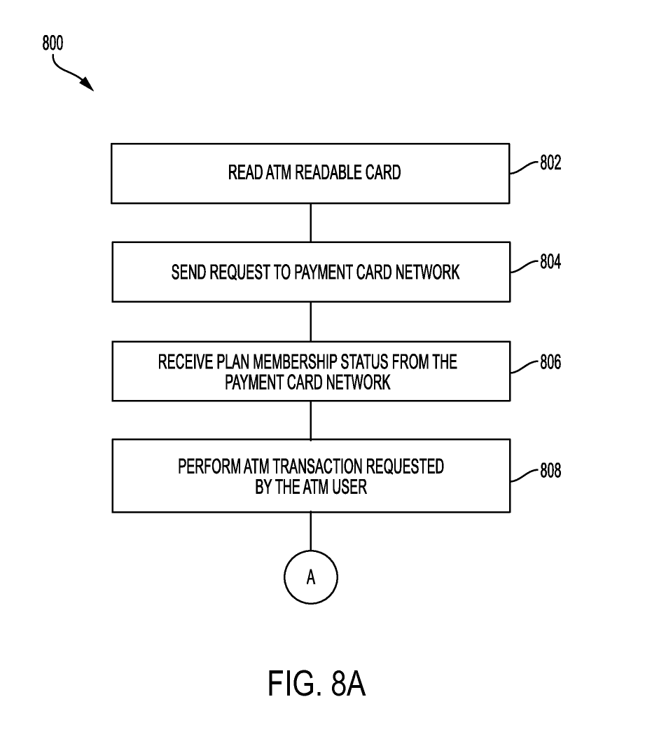

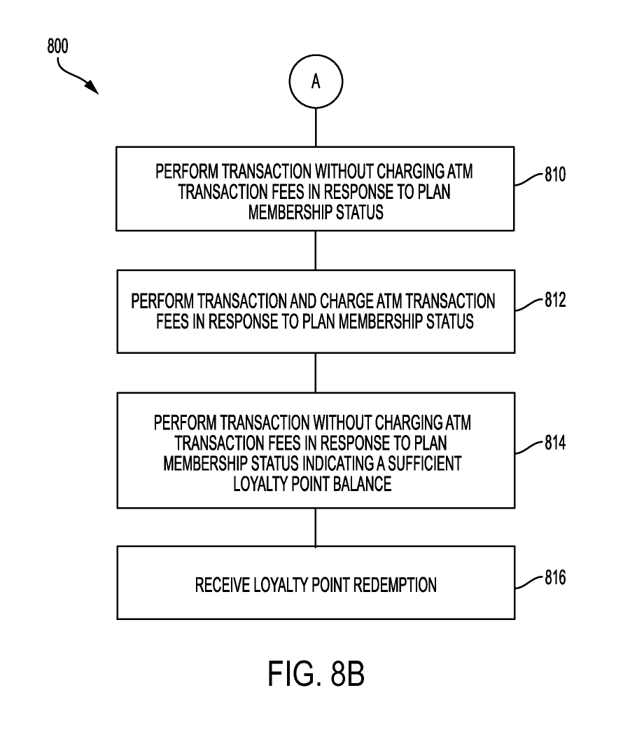

FIGS. 8A and 8B illustrate a method 800 for performing an ATM transaction according to the present disclosure. At block 802 an ATM reads an ATM readable card to access a user account. At block 804 the ATM sends a request to a payment card network that is in communication with card issuers. The request includes a request to one of the card issuers for a plan membership status of the ATM user. At block 806 the ATM receives the plan membership status from the payment card network. At block 808 the requested ATM transaction is performed. At block 810 the requested transaction is performed without charging ATM transaction fees in response to receiving a plan membership status indicating an active membership status of the user. At block 812 the requested transaction is performed and ATM transaction fees are charged to the user in response to receiving a plan membership status indicating a non-active membership status of the user. The plan membership may include a loyalty plan membership, in which case the method may further include performing the requested ATM transaction without charging ATM transaction fees in response to receiving a plan membership status indicating a sufficient loyalty point balance of the user (illustrated as block 814). At block 816 the ATM receives a loyalty point redemption, which is used to pay for at least a portion of a periodic subscription fee of the flat fee program.

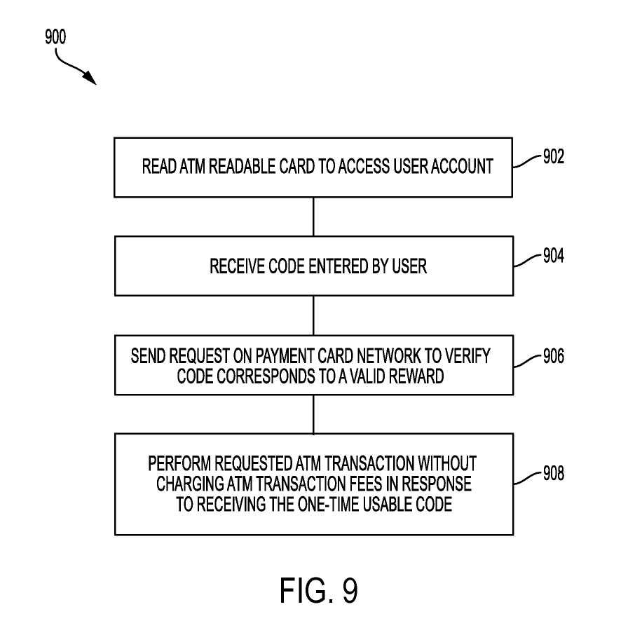

FIG. 9 details a method 900 for performing an ATM transaction according to the present disclosure. At block 902 an ATM reads an ATM readable card to access a user account. At block 904 a code, entered by the user, is received by the ATM. At block 906 a request is sent on a payment card network to verify that the code corresponds to a valid reward. At block 908 an ATM transaction requested by the user is performed without charging ATM transaction fees in response to receiving the one-time usable code.

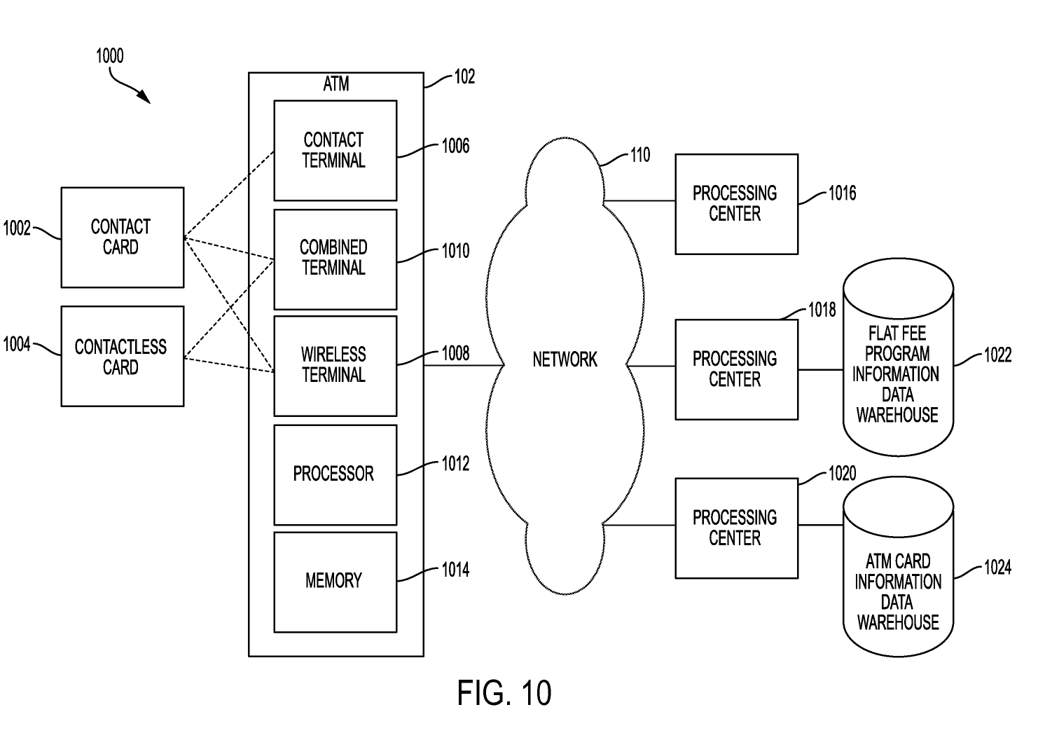

FIG. 10 details a system 1000 for providing a flat fee ATM program. The system 1000 may include one or more different types of payment devices, for example contact and/or contactless cards 1002, 1004, used to facilitate transactions by a cardholder with a terminal of the ATM 102, such as the contact, wireless, or combined terminals 1006, 1008, 1010 described in detail hereafter. The contact card 1002 may be a device that interacts with transaction terminals using physical communication. Thus, the contact card 1002 may have a magnetic stripe. The contactless card 1004 may be a device that interacts with transaction terminals without physical communication. Thus, the contactless card 1004 may have an antenna that provides for contactless communication, such as by using radio frequency (RF) electromagnetic waves, for example. Each of the cards 1002, 1004 may contain an integrated circuit (“IC”) chip having a processor portion and a memory portion. The ICs may also include one or more of control logic, a timer, and input/output ports. Such elements are well known in the IC art and are not separately illustrated. One or both of the ICs may also include a co-processor, again, well-known and not separately illustrated. The control logic may provide, in conjunction with the processing portion, the control necessary to handle communications between the memory portion and the input/output ports. The timer may provide a timing reference signal from the processing portion and the control logic. The co-processor may provide the ability to perform complex computations in real time, such as those required by cryptographic algorithms.

The memory portions of both the cards 1002, 1004 may include different types of memory, such as volatile and non-volatile/flash memory and read-only and programmable memory. The memory portions may store the operating system of the cards 1002, 1004. The operating system loads and executes applications and provides file management or other basic device services to the applications. The operating system may be stored in read-only memory (“ROM”) within the memory portion.

In addition to the basic services provided by the operating system, the memory portions may also include one or more applications. At present, one possible specification to which such applications may conform is the EMV interoperable payments specification set forth by EMVCo, LLC (901 Metro Center Boulevard, Mailstop M3-3D, Foster City, Calif., 94404, USA). It will be appreciated that, strictly speaking, the EMV specification defines the behavior of a terminal; however, the card may be configured to conform to such EMV-compliant terminal behavior and in this sense is itself EMV-compliant. It will be appreciated that applications may be configured in a variety of different ways.

The contact terminal 1006 may interface with the contact card 1002 through means such as a magnetic stripe terminal. The wireless terminal 1008 may interface with both the contact and contactless cards 1002, 1004. The combined terminal 1010 may interface with both the contact card 1002 as well as the contactless card 1004. In operation, the contact card 1002 may be swiped on the contact terminal 1006, or may be touched or tapped on the wireless or combined terminals 1008, 1010, which then contactlessly transmits the electronic data to the proximity IC chip in the contact card 1002. Thus, the above-described cards 1002, 1004 may be ISO 7816-compliant contact cards or devices or NFC (Near Field Communications) or ISO 14443-compliant proximity cards or devices.

The terminals 1006, 1008, 1010 may function via hardware techniques in the processor 1012, or by program instructions stored in the memory 1014. Such logic could optionally be provided from a central location such as one of the processing centers 1016, 1018, 1020 over the network 110.

The one or more processing centers 1016, 1018, 1020 may be connected to the ATM 102 via the network 110. The network 110 may include, for example, the Internet, or a proprietary network. Moreover, more than one network 110 may be employed to connect different elements of the system 1000. The processing centers 1016, 1018, 1020 may include, for example, a host computer of an issuer of an ATM card, such as the contact and contactless cards 1002, 1004.

The processing center 1018 may be in communication with a database such as the flat fee program information data warehouse 1022, which may contain various information pertaining to ATM cards enrolled in the flat fee ATM program. The processing center 1020 may be in communication with a database such as the ATM card information data warehouse 1024, which may contain various information pertaining to ATM card accounts. The processing centers 1016, 1018, 1020 may be operably connected in order to share information. For example, the processing centers 1016, 1018, 1020 may be connected to allow the interchange of information between the data warehouse 1022, 1024 and the ATM 102.

Embodiments of the present disclosure are described herein with reference to the accompanying drawings. However, the present disclosure should not be construed as limited to the embodiments set forth herein. Rather, these embodiments are provided so that this disclosure will be thorough and complete, and will fully convey the scope of the present disclosure to those skilled in the art. Like numbers refer to like elements throughout. As used herein, the term “and/or” includes any and all combinations of one or more of the associated listed items and may be abbreviated as “/”.

The terminology used herein is for the purpose of describing particular embodiments only and is not intended to be limiting of the present disclosure. As used herein, the singular forms “a,” “an,” and “the” are intended to include the plural forms as well, unless the context clearly indicates otherwise. It will be further understood that the terms “comprises,” “comprising,” “having,” “includes,” “including,” and/or variations thereof, when used in this specification, specify the presence of stated features, steps, operations, elements, and/or components, but do not preclude the presence or addition of one or more other features, steps, operations, elements, components, and/or groups thereof.

It should be understood that when an element is referred to as being “connected” or “coupled” to another element (or variations thereof), it can be directly connected or coupled to the other element or intervening elements may be present. In contrast, when an element is referred to as being “directly connected” or “directly coupled” to another element (or variations thereof), there are no intervening elements present.

It will be understood that, although the terms first, second, etc. may be used herein to describe various elements and/or components, these elements and/or components should not be limited by these terms. These terms are only used to distinguish one element and/or component from another element and/or component. Thus, a first element or component discussed below could be termed a second element or component without departing from the teaching of the present disclosure.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Although aspects of the present disclosure are described in terms of various types of payment cards and payment card accounts, it should be understood that the disclosure is not limited to physical cards or accounts associated with physical cards. For example, various payment devices, such as smart phones, tablet computers, and other wireless devices may be used in place of a payment cards within the scope of the present disclosure. It should be understood that such payment device can be used in the same way as a payment card according to aspects of the present disclosure.

Although the present disclosure has been described in connection with the embodiments of the present disclosure illustrated in the accompanying drawings, it is not limited thereto. The above-disclosed subject matter is to be considered illustrative, and not restrictive, and the appended claims are intended to cover all such modifications, enhancements, and other embodiments, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

Although specific components have been set forth, it will be appreciated by those skilled in the art that not all of the disclosed components are required to practice the disclosed configurations. Moreover, certain well known components have not be described, to maintain focus on the disclosure.

For firmware and/or software implementation, the methodologies may be implemented with modules (e.g., procedures, functions, and so on) that perform the functions described herein. A machine-readable medium tangibly embodying instructions may be used in implementing the methodologies described herein. For example, software codes may be stored in a memory and executed by a processor unit. Memory may be implemented within the processor unit or external to the processor unit. As used herein, the term “memory” refers to types of long term, short term, volatile, nonvolatile, or other memory and is not to be limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disc storage, magnetic disk storage or other magnetic storage devices, or other medium that can be used to store desired program code in the form of instructions or data structures and that can be accessed by a computer. Disk and disc, as used herein, includes compact disc (CD), laser disc, optical disc, digital versatile disc (DVD), floppy disk, and blu-ray disc, where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communication apparatus. For example, a communication apparatus may include a transceiver having signals indicative or instructions and data. The instructions and data are configured to cause one or more processors to implement the functions outlined in the claims.

Although the present disclosure and its advantages have been described in detail, it should be understood that various changes, substitutions, and alterations can be made herein without departing from the spirit and scope of the disclosure as defined by the appended claims. Moreover, the scope of the present application is not intended to be limited to the particular configurations of the process, machine, manufacture, composition of matter, means, methods, and steps described in the specification. As one of ordinary skill in the art will readily appreciate from the present disclosure, processes, machines, manufacture, compositions of matter, means, methods, or steps presently existing or later to be developed that perform substantially the same functions or achieve substantially the same result as the corresponding configurations described herein may be utilized according to the present disclosure. Accordingly, the appended claims are intended to include within their scope such processes, machines, manufacture, compositions of matter, means, methods, or steps.

What is claimed is:

1. A method for performing an ATM transaction comprising the steps of:
receiving a debit order and an inquiry from an ATM, the debit order including a requested transaction amount and the inquiry including identifying information associated with a transacted ATM card;
sending the debit order to a payment card network, the payment card network being coupled to a plurality of ATM card issuers;
receiving a response to the debit order from the payment card network;
accessing a flat fee program database using the identifying information of the inquiry to determine whether the transacted ATM card is enrolled in a flat fee ATM program; and
sending instructions to the ATM, the instructions relating to whether a requested transaction should be performed and whether a transaction fee should be applied to the requested transaction.

2. The method of claim 1 wherein the flat fee program database includes account information of ATM cards enrolled in the flat fee ATM program.

3. The method of claim 1 wherein the flat fee program database includes at least one of ATM card numbers and user identifying information.

4. The method of claim 1 further comprising the step of:
determining whether the response to the debit order indicates a user account affiliated with the ATM card has sufficient funds to back the requested transaction.

5. The method of claim 1 wherein the debit order includes payment card network information identifying the payment card network affiliated with the transacted ATM card.

6. The method of claim 1 wherein the payment card network is a card association affiliated with the transacted ATM card.

7. A method for performing an ATM transaction comprising the steps of:
receiving a debit order and an inquiry from an ATM, the debit order including a requested transaction amount;
sending the debit order and the inquiry to a payment card network, the payment card network being coupled to a plurality of ATM card issuers;
receiving a response to the debit order and the inquiry from the payment card network, the response indicating whether sufficient funds exist in a user account to back the requested transaction amount and whether a transacted ATM card is enrolled in a flat fee ATM program; and
sending instructions to the ATM, the instructions relating to whether a requested transaction should be performed and whether a transaction fee should be applied to the requested transaction.

8. The method of claim 7 further comprising the step of:
determining whether the response indicates the transacted ATM card is enrolled in the flat fee program.

9. The method of claim 7 wherein at least one of the debit order and the inquiry include information identifying the payment card network affiliated with the transacted ATM card.

10. The method of claim 7 wherein the inquiry includes a request for information evidencing whether the transacted ATM card is enrolled in the flat fee ATM program.

11. An device for providing a flat fee ATM program comprising:
a memory;
a processor operatively coupled to the memory; and
a persistent storage device operatively coupled to the memory and storing in a non-transitory manner instructions that when loaded into the memory cause the processor to be operative to:
receive a debit order and an inquiry from an ATM, the debit order and the inquiry being specific to a requested ATM transaction, the inquiry including information useable for determining whether a transacted ATM card is enrolled in a flat fee ATM program;
transmit at least one of the debit order and the inquiry to a payment card network, the payment card network being coupled to a plurality of ATM card issuers;
receive a response to at least one of the debit order and the inquiry from the payment card network;
determine whether the requested ATM transaction should be assessed a transaction fee; and
transmit instructions to the ATM stating whether the requested ATM transaction should be assessed the transaction fee.

12. The device of claim 11 wherein the processor is operative to analyze the response to determine whether the transacted ATM card is enrolled in the flat fee ATM program.

13. The device of claim 11 wherein the processor is operative to access a flat fee ATM program database to determine whether the transacted ATM card is enrolled in the flat fee ATM program.

14. The device of claim 13 wherein the flat fee ATM program database includes ATM card numbers affiliated with ATM cards enrolled in the flat fee ATM program.

15. The device of claim 11 wherein the debit order includes at least one of a requested transaction amount, ATM card identifying information, affiliated payment card network information, and affiliated ATM card issuer information.

16. The device of claim 11 wherein the processor is operative to determine whether the requested ATM transaction should be performed.

17. The device of claim 11 wherein the processor is operative to analyze the response to determine whether the requested ATM transaction should be performed.

18. The device of claim 11 wherein the processor is operative to transmit instructions to the ATM stating whether the requested ATM transaction should be performed.

19. The device of claim 11 wherein the inquiry includes at least one of ATM card identifying information, affiliated user information, affiliated payment card network information, and affiliated ATM card issuer information.

20. The device of claim 11 wherein the processor is operative to transmit at least one of the debit order and the inquiry to the payment card network using affiliated payment card network information contained within at least one of the debit order and the inquiry.

21. A method for performing an ATM transaction, comprising:
reading an ATM readable card by an ATM to access a user account;
sending a request by the ATM to a payment card network, wherein the payment card network is coupled to a plurality of card issuers and wherein the request includes a request to one of the card issuers for a plan membership status of the user;
receiving the plan membership status from the payment card network by the ATM;
performing an ATM transaction requested by the user without charging ATM transaction fees to the user in response to receiving the plan membership status indicating an active membership status of the user.

22. The method of claim 21, comprising:
performing an ATM transaction requested by the user; and
charging ATM transaction fees to the user in response to receiving the plan membership status indicating an non-active membership status of the user.

23. The method of claim 21, wherein the entity is an ATM network operator.

24. The method of claim 21, wherein the entity is a card network operator.

25. The method of claim 21, wherein the plan membership comprises a loyalty plan membership, the method further comprising:
performing an ATM transaction requested by the user without charging ATM transaction fees to the user in response to receiving the plan membership status indicating a sufficient loyalty point balance of the user.

26. The method of claim 21 further comprising:
receiving a loyalty point redemption by the ATM, the loyalty point redemption used to pay for at least a portion of a periodic subscription fee of the user.

27. A method for performing an ATM transaction, comprising:
reading an ATM readable card by an ATM to access a user account;
receiving a code entered to the ATM by the user;
sending a request on a payment card network to verify that the code corresponds to a valid reward;
performing an ATM transaction requested by the user without charging ATM transaction fees to the user in response to receiving the one-time usable code.

28. An electronic funds transfer (EFT) system, comprising:
an automatic teller machine (ATM) operator computer coupled to an ATM, the ATM operator computer comprising at least one processor and at least one data storage apparatus;
a subscription database stored in the at least one data storage apparatus, the subscription database containing status information indicating a subscription status of a plurality of subscriber ATM cardholders;
the ATM operator computer being configured to:
receive a transaction request from the ATM including account identifying information of an ATM user;
search the subscription database for information indicating the subscription status of the ATM user based on the account identifying information;
determine the subscription status of the ATM user based on the status information; and
when the subscription status of the ATM user is determined to be active, transmitting a no-fee authorization to the ATM.

29. The EFT system of claim 28 wherein the ATM is configured to charge a surcharge per transaction to the ATM user unless the no-fee authorization is transmitted by the ATM operator computer.

30. The EFT system of claim 28, wherein the ATM operator is configured to invite cardholders to subscribe to a no-fee ATM program and store identifying information within the subscription database, the ATM operator further being configured to notify the cardholders that they are subscribed to the no-fee ATM program.

31. The EFT system of claim 28, further comprising clearing the transaction and/or the surcharge by debiting/crediting an account of the ATM user via a payment card network,

32. The EFT system of claim 28, further comprising charging a subscription fee to the account of the ATM user periodically via the a payment card network.

33. An electronic funds transfer system, comprising:
an ATM network computer coupled to one or more financial institution computers and one or more ATM operator computers, in which the one or more ATM operator computers are each coupled to one or more ATMs, the ATM network computer comprising at least one processor and at least one data storage apparatus;
a subscription database stored in the at least one data storage apparatus, the subscription database containing status information indicating a subscription status of a plurality of subscriber ATM cardholders;
the ATM network computer being configured to:
receive a transaction request from the ATM via at least one of the ATM operator computers, the transaction request including account identifying information of an ATM user;
search the subscription database for information indicating the subscription status of the ATM user based on the account identifying information;
determine the subscription status of the ATM user based on the status information; and
when the subscription status of the ATM user is determined to be active, transmitting a no-fee authorization to the ATM via the at least one of the ATM operator computers.
